(19) United States
(12) Patent Application Publication
(10) Pub. No.: US 2024/0428176 A1
(43) Pub. Date: Dec. 26, 2024

(54) FOOD WASTE REDUCTION THROUGH COLLABORATIVE REFRIGERATOR INVENTORY ANALYSIS AND MEAL PLANNING

(71) Applicant: International Business Machines Corporation, Armonk, NY (US)

(72) Inventors: JAZMIN RODRIGUEZ AGUILERA, Zapopan (MX); Carolina Garcia Delgado, Zapopan (MX); Jeremy R. Fox, Georgetown, TX (US); Sarbajit K. Rakshit, Kolkata (IN)

(21) Appl. No.: 18/339,423

(22) Filed: Jun. 22, 2023

(51) Int. Cl. G06Q 10/0832; G06Q 10/087; G06Q 30/0601; G06V 10/56; G06V 20/17; G06V 20/68

(52) U.S. Cl. CPC G06Q 10/0832; G06Q 10/087; G06Q 30/0633; G06V 10/56; G06V 20/17; G06V 20/68

(57) ABSTRACT

In an approach for creating a virtual network of smart refrigerators and tracking a plurality of food inventories, a processor creates a virtual refrigerator network by connecting a plurality of smart refrigerators. A processor gathers an inventory of one or more products stored in the plurality of smart refrigerators. A processor generates a recipe suggestion based on the one or more products, wherein the one or more products have at least one of a freshness level and an expiration date within a predetermined threshold. Responsive to one or more users each associated with one or more of the plurality of smart refrigerators accepting the recipe suggestion, a processor gathers a subset of the one or more products involved in the recipe suggestion. Responsive to determining a meal has been prepared, a processor delivers a respective portion of the meal to each household of the one or more users.

### BACKGROUND OF THE INVENTION

The present invention relates generally to the field of data processing, and more particularly to food waste reduction through collaborative refrigerator inventory analysis and meal planning.

In the United States, nearly 40 percent of the food supply—or 119 billion pounds of food—is wasted each year. That is equal to 130 billion meals and more than $408 billion in food thrown away each year.

Food goes to waste at every stage of food production and distribution. That includes farmers, packers and shippers, manufacturers, retailers, and our homes. The waste is categorized differently based on where it occurs: (1) food “loss” occurs before the food reaches the consumer as a result of issues in the production, storage, processing, and distribution phases; and (2) food “waste” occurs when food is fit for consumption but is consciously discarded at the retail or consumption phases.

Food goes to waste for a variety of reasons, including losses from mold, pests, or inadequate climate control; losses from cooking; and intentional food waste. One of the main contributors to food waste is the mismanagement of perishable items in our homes and at the retail level. Many individuals and homes struggle to keep track of expiration dates and do not have effective strategies in place for using up their perishable items before they spoil. At the same time, retailers often discard large quantities of perfectly edible food due to expiration dates or cosmetic imperfections.

### SUMMARY

Aspects of an embodiment of the present invention disclose a method, computer program product, and computer system for creating a virtual network of smart refrigerators, including a user's smart refrigerator and one or more community members' smart refrigerators, and tracking a plurality of food inventories using visual inspection. A processor creates a virtual refrigerator network by connecting a plurality of smart refrigerators. A processor gathers an inventory of one or more products stored in the plurality of smart refrigerators and a set of data related to the inventory, wherein the set of data related to the inventory includes at least one of a freshness level of the one or more products and an expiration date of the one or more products. A processor generates a recipe suggestion based on the one or more products stored in the plurality of smart refrigerators, wherein the one or more products have at least one of the freshness level and the expiration date within a first predetermined threshold. Responsive to one or more users each associated with one or more of the plurality of smart refrigerators accepting the recipe suggestion, a processor gathers a subset of the one or more products involved in the recipe suggestion from respective smart refrigerators of the plurality of smart refrigerators to prepare the recipe suggestion, wherein the subset of the one or more products gathered are delivered to a central location. Responsive to determining a meal has been prepared, a processor delivers a respective portion of the meal to each household of the one or more users.

In some aspects of an embodiment of the present invention, the plurality of smart refrigerators is each connected through an application programming interface.

In some aspects of an embodiment of the present invention, each of the plurality of smart refrigerators are located within a pre-determined distance from each other.

In some aspects of an embodiment of the present invention, a processor creates a first user profile for a first user associated with a first smart refrigerator of the plurality of smart refrigerators from a set of data input by at least one of the first user, a first camera located in a first door of the first smart refrigerator, and a drone. A processor stores the first user profile in a database.

In some aspects of an embodiment of the present invention, the inventory of the one or more products stored in the plurality of smart refrigerators and the set of data related to the inventory are gathered from at least one of the one or more users each associated with the one or more of the plurality of smart refrigerators and one or more of a plurality of cameras located in one or more of a plurality of doors of the one or more of the plurality of smart refrigerators.

In some aspects of an embodiment of the present invention, responsive to the first user shopping at a supermarket for the one or more products, a processor connects to a virtual shopping cart of the supermarket. A processor tracks the one or more products added to the virtual shopping cart of the supermarket. A processor validates the one or more products against an inventory of the first smart refrigerator of the plurality of smart refrigerators. Responsive to determining that there is a risk of food waste, a processor outputs an alert notification to the first user.

In some aspects of an embodiment of the present invention, a processor compares a first picture of a first product input by at least one of the first user associated with a first smart refrigerator of the plurality of smart refrigerators and the first camera of the one or more of the plurality of cameras located in the one or more of the plurality of doors of the one or more of the plurality of smart refrigerators to a second product in a second picture from a library of pictures. A processor determines whether a color of the first product is similar to a color of the second product in the second picture in the library of pictures. A processor calculates an age of the first product.

In some aspects of an embodiment of the present invention, a processor delivers, while delivering the respective portion of the meal to each household of the one or more users, food waste resulting from a preparation of the meal to be used as compost, the first household being selected based, at least in part, on a processor analyzing a ground condition of the first household when gathering the one or more products from the one or more users to prepare the recipe suggestion; and a processor determining the ground condition of the first household is below a second predetermined threshold.

In some aspects of an embodiment of the present invention, the respective portion of the meal is delivered to each household of the first user and the one or more contributing users using a drone.

These and other features and advantages of the present invention will be described in, or will become apparent to those of ordinary skill in the art in view of, the following detailed description of the example embodiments of the present invention.

### BRIEF DESCRIPTION OF THE DRAWINGS

FIG. 1 is a functional block diagram illustrating a distributed data processing environment, in accordance with an embodiment of the present invention;

FIG. 2 is a flowchart illustrating the operational steps of a food waste reduction program, on a server within the distributed data processing environment of FIG. 1, in accordance with an embodiment of the present invention;

FIG. 3A is a diagram illustrating an initialization of a virtual refrigerator network, in accordance with an embodiment of the present invention;

FIG. 3B is a diagram illustrating a generation of a recipe with one or more products having a freshness level and/or an expiration date within a pre-determined threshold, in accordance with an embodiment of the present invention;

FIG. 3C is a diagram illustrating a gathering of the one or more products for the recipe generated using a drone, in accordance with an embodiment of the present invention;

FIG. 3D is a diagram illustrating an analyzation of a ground condition of a household to determine where to send compost created from food waste resulting from a preparation of a meal, in accordance with an embodiment of the present invention;

FIG. 4 is a diagram illustrating a formation of a supply chain network between a supermarket and one or more restaurants, in accordance with an embodiment of the present invention; and

FIG. 5 depicts a block diagram of components of a computing environment representing the distributed data processing environment of FIG. 1, in accordance with an embodiment of the present invention.

### DETAILED DESCRIPTION

Embodiments of the present invention recognize that food waste has far-reaching effects, both nationally and globally. In the United States, up to forty percent of all food produced goes uneaten, and about eighty-five percent of discarded food ends up in landfills. It is the largest component of municipal solid waste at twenty-one percent. In 2014, more than thirty-eight million tons of food waste was generated, with only five percent diverted from landfills and incinerators for composting. Decomposing food waste produces methane, a strong greenhouse gas that contributes to global warming. Worldwide, one-third of food produced is thrown away uneaten, causing an increased burden on the environment. It is estimated that reducing food waste by fifteen percent could feed more than twenty-five million Americans every year.

Embodiments of the present invention recognize the benefits of reducing food waste, including cost savings on labor through more efficient handling, preparation, and storage of food that will be used; cost savings when purchasing only as much food as needed, and avoiding additional costs of disposal; reduced methane emissions from landfills and a lower carbon footprint; better management of energy and resources, preventing pollution involved in the growing, manufacturing, transporting, and selling of food; and community benefits by providing donated, untouched, and safe food that would otherwise be thrown out.

Therefore, embodiments of the present invention recognize the need for a system and method to address this issue by providing individuals and households with better tools for managing their perishable items and reducing food waste. Such a solution could have a significant impact on reducing global food waste, as well as helping individuals and households save money and resources.

Embodiments of the present invention provide a system and method to create a virtual network of smart refrigerators, including a user's smart refrigerator and one or more community members' smart refrigerators, and to track a plurality of food inventories using visual inspection. Embodiments of the present invention provide a system and method to monitor the freshness of food in the virtual network of smart refrigerators and to suggest one or more recipes based on a freshness level and/or an expiration date of the food in the virtual network of smart refrigerators to reduce food waste. Embodiments of the present invention provide a system and method to use a drone to collect one or more ingredients of the one or more recipes suggested and to deliver the one or more ingredients and/or a pre-prepared meal to a user to promote resource efficiency. Embodiments of the present invention provide a system and method to analyze a condition of one or more plants in a user's yard and to suggest a way to compost food waste to promote environmental sustainability.

Implementation of embodiments of the present invention may take a variety of forms, and exemplary implementation details are discussed subsequently with reference to the Figures.

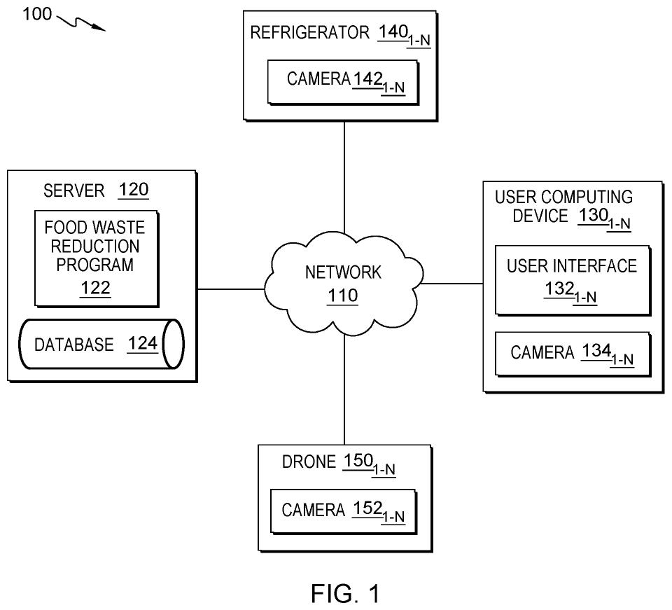

FIG. 1 is a block diagram illustrating a distributed data processing environment, generally designated 100, in accordance with an embodiment of the present invention. In the depicted embodiment, distributed data processing environment 100 includes server 120, user computing devices 130_{1-N}, smart refrigerators 140_{1-N}, and drones 150_{1-N} interconnected over network 110. Distributed data processing environment 100 may include additional servers, computers, computing devices, and other devices not shown. The term “distributed” as used herein describes a computer system that includes multiple, physically distinct devices that operate together as a single computer system. FIG. 1 provides only an illustration of one embodiment of the present invention and does not imply any limitations with regards to the environments in which different embodiments may be implemented. Many modifications to the depicted environment may be made by those skilled in the art without departing from the scope of the invention as recited by the claims.

Network 110 operates as a computing network that can be, for example, a telecommunications network, a local area network (LAN), a wide area network (WAN), such as the Internet, or a combination of the three, and can include wired, wireless, or fiber optic connections. Network 110 can include one or more wired and/or wireless networks capable of receiving and transmitting data, voice, and/or video signals, including multimedia signals that include data, voice, and video information. In general, network 110 can be any combination of connections and protocols that will support communications between server 120, user computing devices 130_{1-N}, smart refrigerators 140_{1-N}, drones 150_{1-N}, and other computing devices, smart refrigerators, and drones (not shown) within distributed data processing environment 100.

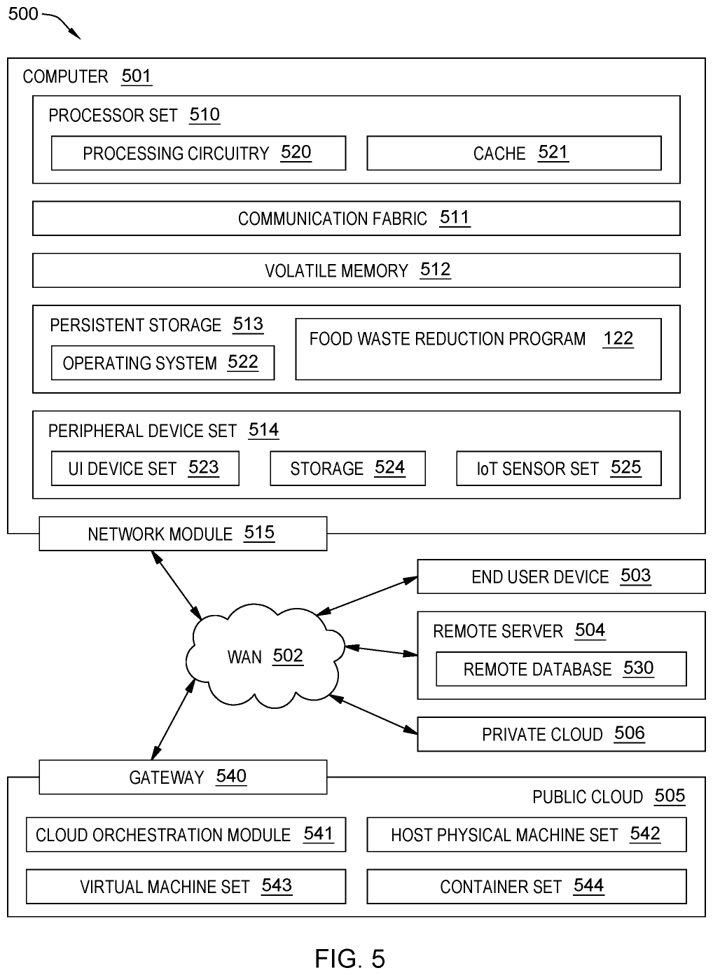

Server 120 operates to run food waste reduction program 122 and to send and/or store data in database 124. In an embodiment, server 120 can send data from database 124 to user computing devices 130_{1-N}, smart refrigerators 140_{1-N}, and drones 150_{1-N}. In an embodiment, server 120 can receive data in database 124 from user computing devices 130_{1-N}, smart refrigerators_{1-N}, and drones 150_{1-N}. In one or more embodiments, server 120 can be a standalone computing device, a management server, a web server, a mobile computing device, or any other electronic device or computing system capable of receiving, sending, and processing data and capable of communicating with user computing devices 130_{1-N}, smart refrigerators 140_{1-N}, and drones 150_{1-N} via network 110. In one or more embodiments, server 120 can be a computing system utilizing clustered computers and components (e.g., database server computers, application server computers, etc.) that act as a single pool of seamless resources when accessed within distributed data processing environment 100, such as in a cloud computing environment. In one or more embodiments, server 120 can be a laptop computer, a tablet computer, a netbook computer, a personal computer, a desktop computer, a personal digital assistant, a smart phone, or any programmable electronic device capable of communicating with user computing devices 130_{1-N}, smart refrigerators 140_{1-N}, drones 150_{1-N} and other computing devices, smart refrigerators, and drones (not shown) within distributed data processing environment 100 via network 110. Server 120 may include internal and external hardware components, as depicted and described in further detail in FIG. 5.

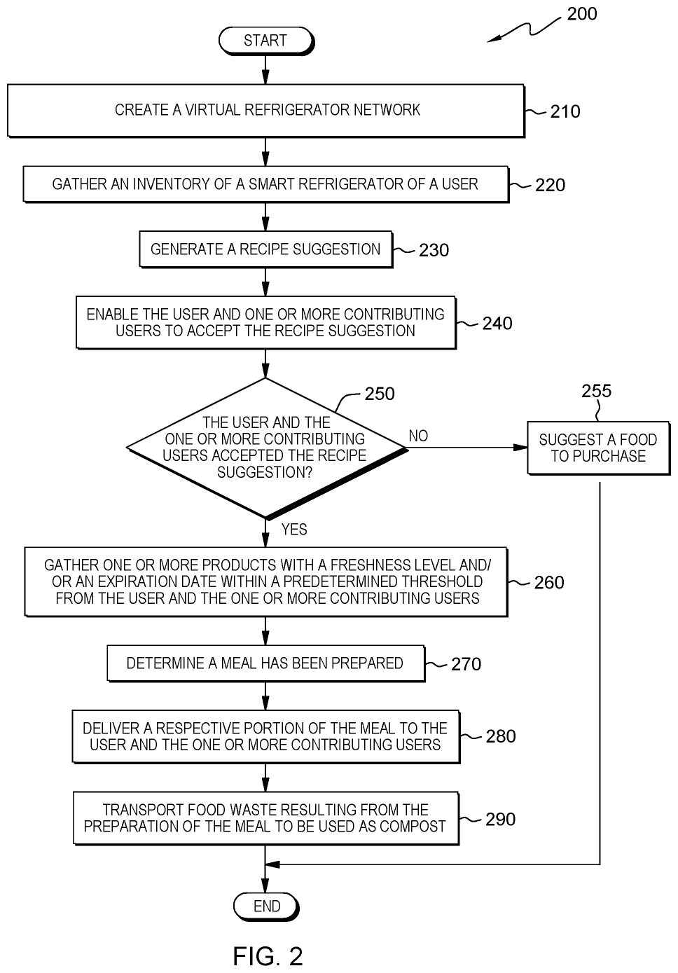

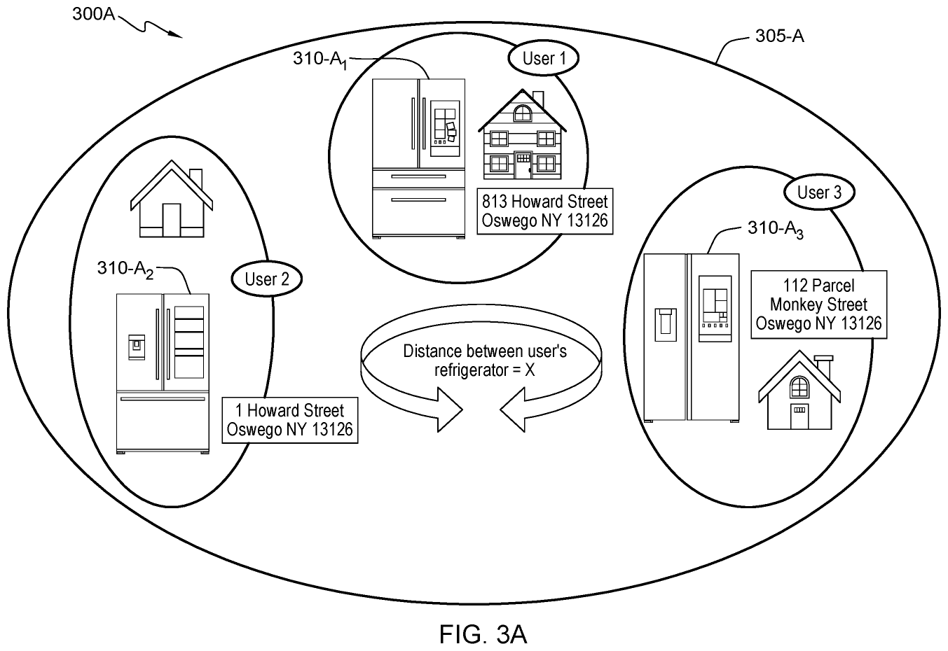

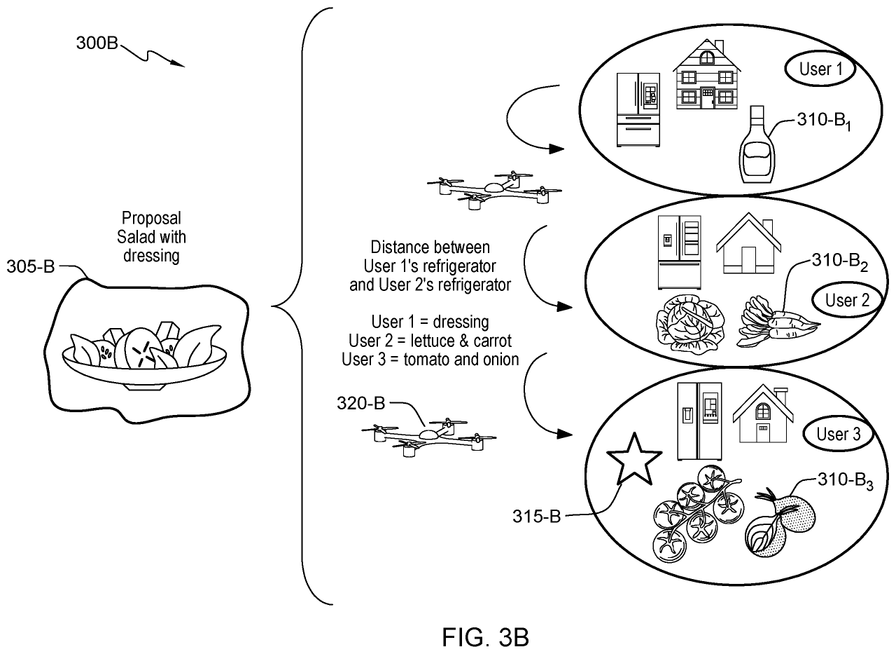

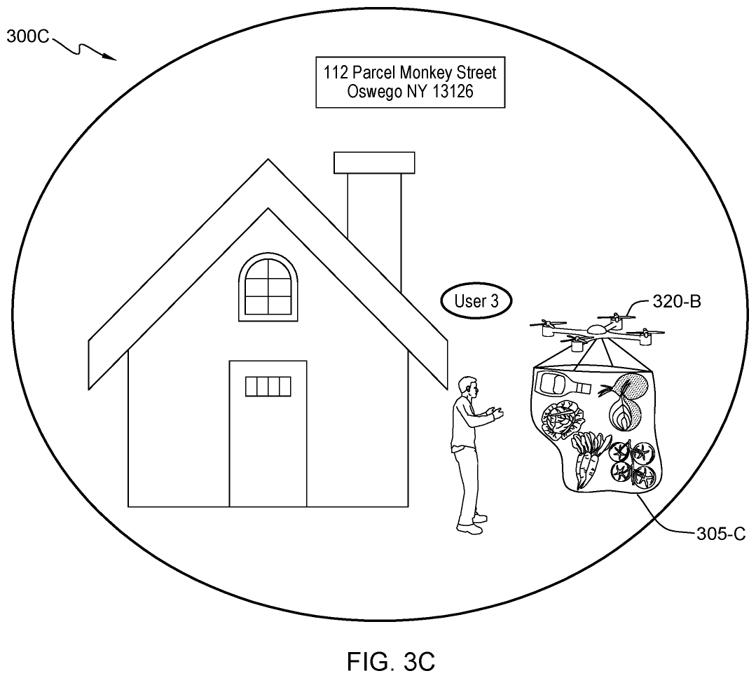

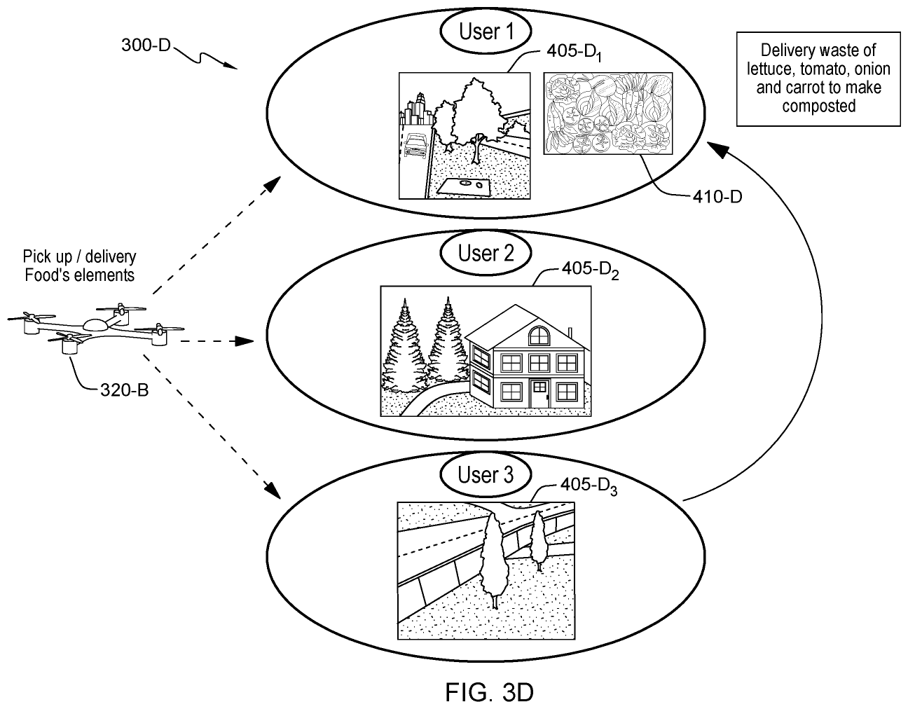

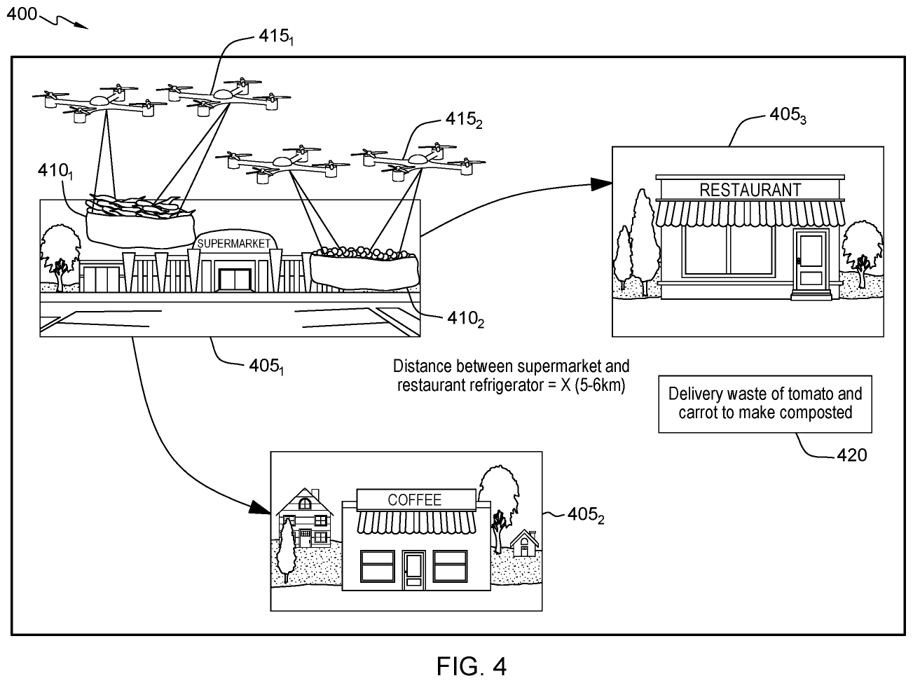

Food waste reduction program 122 operates to create a virtual network of smart refrigerators, including a user's smart refrigerator and one or more community members' smart refrigerators, and to track a plurality of food inventories using visual inspection. Food waste reduction program 122 operates to monitor the freshness of food in the virtual network of smart refrigerators and to suggest one or more recipes based on a freshness level and/or an expiration date of the food in the virtual network of smart refrigerators to reduce food waste. Food waste reduction program 122 operates to use a drone to gather one or more ingredients of the one or more recipes suggested and to deliver the one or more ingredients and/or a pre-prepared meal to a user to promote resource efficiency. Food waste reduction program 122 operates to analyze a condition of one or more plants in a user's yard and to suggest a way to compost food waste to promote environmental sustainability. In the depicted embodiment, food waste reduction program 122 is a standalone program. In another embodiment, food waste reduction program 122 may be integrated into another software product, e.g., smart refrigerator software package. In the depicted embodiment, food waste reduction program 122 resides on server 120. In another embodiment, food waste reduction program 122 may reside on another computing device (not shown), provided food waste reduction program 122 has access to network 110. The operational steps of food waste reduction program 122 are depicted and described in further detail with respect to FIG. 2. A diagram illustrating an initialization of a virtual refrigerator network is depicted and described in further detail with respect to FIG. 3A. A diagram illustrating a generation of a recipe with one or more products having a freshness level and/or an expiration date within a pre-determined threshold is depicted and described in further detail with respect to FIG. 3B. A diagram illustrating a gathering of the one or more products for the recipe generated using a drone is depicted and described in further detail with respect to FIG. 3C. A diagram illustrating an analyzation of a ground condition of a household to determine where to send compost created from food waste resulting from a preparation of a meal is depicted and described in further detail with respect to FIG. 3D. A diagram illustrating a formation of a supply chain network between a supermarket and one or more restaurants is depicted and described in further detail with respect to FIG. 4.

In an embodiment, the user of a user computing device (e.g., user computing device 130x of user computing devices 130_{1-N}) registers with food waste reduction program 122 of server 120. For example, the user completes a registration process (e.g., user validation), provides information to create a user profile, and authorizes the collection, analysis, and distribution (i.e., opts-in) of relevant data on an identified computing device (e.g., on user computing device 130x of user computing devices 130_{1-N}) by server 120 (e.g., via food waste reduction program 122). Relevant data includes, but is not limited to, personal information or data provided by the user; tagged and/or recorded location information of the user (e.g., to infer context (i.e., time, place, and usage) of a location or existence); time stamped temporal information (e.g., to infer contextual reference points); and specifications pertaining to the software or hardware of the user's device. In an embodiment, the user opts-in or opts-out of certain categories of data collection. For example, the user can opt-in to provide all requested information, a subset of requested information, or no information. In one example scenario, the user opts-in to provide time-based information, but opts-out of providing location-based information (on all or a subset of computing devices associated with the user). In an embodiment, the user opts-in or opts-out of certain categories of data analysis. In an embodiment, the user opts-in or opts-out of certain categories of data distribution. Such preferences can be stored in database 124.

Database 124 operates as a repository for data received, used, and/or generated by food waste reduction program 122. A database is an organized collection of data. Data includes, but is not limited to, information about user preferences (e.g., general user system settings such as alert notifications for user computing devices 130_{1-N}); information about alert notification preferences; a user profile; a set of personal data input by a user, a set of data gathered from a camera, and a set of data gathered from a drone; an inventory of a smart refrigerator; a set of data related to the inventory of the smart refrigerator; a First-In-First-Out (FIFO) list of the smart refrigerator; a picture captured of the ground condition; and any other data received, used, and/or generated by food waste reduction program 122.

Database 124 can be implemented with any type of device capable of storing data and configuration files that can be accessed and utilized by server 120, such as a hard disk drive, a database server, or a flash memory. In an embodiment, database 124 is accessed by food waste reduction program 122 to store and/or to access the data. In the depicted embodiment, database 124 resides on server 120. In another embodiment, database 124 may reside on another computing device, server, cloud server, or spread across multiple devices elsewhere (not shown) within distributed data processing environment 100, provided that food waste reduction program 122 has access to database 124.

The present invention may contain various accessible data sources, such as database 124, that may include personal and/or confidential company data, content, or information the user wishes not to be processed. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal and/or confidential company data. Food waste reduction program 122 enables the authorized and secure processing of personal data and/or confidential company data.

Food waste reduction program 122 provides informed consent, with notice of the collection of personal and/or confidential company data, allowing the user to opt-in or opt-out of processing personal and/or confidential company data. Consent can take several forms. Opt-in consent can impose on the user to take an affirmative action before personal and/or confidential company data is processed. Alternatively, opt-out consent can impose on the user to take an affirmative action to prevent the processing of personal and/or confidential company data before personal and/or confidential company data is processed. Food waste reduction program 122 provides information regarding personal and/or confidential company data and the nature (e.g., type, scope, purpose, duration, etc.) of the processing. Food waste reduction program 122 provides the user with copies of stored personal and/or confidential company data. Food waste reduction program 122 allows the correction or completion of incorrect or incomplete personal and/or confidential company data. Food waste reduction program 122 allows for the immediate deletion of personal and/or confidential company data.

User computing devices 130_{1-N} operate to run user interfaces 132_{1-N} and cameras 134_{1-N} respectively through which a user can interact with food waste reduction program 122 on server 120. As used herein, N represents a positive integer, and accordingly the number of scenarios implemented in a given embodiment of the present invention is not limited to those depicted in FIG. 1. In an embodiment, user computing devices 130_{1-N} are devices that perform programmable instructions. For example, user computing devices 130_{1-N} may be an electronic device, such as a laptop computer, a tablet computer, a netbook computer, a personal computer, a desktop computer, a smart phone, or any programmable electronic device capable of running user interfaces 132_{1-N} and cameras 134_{1-N} and of communicating (i.e., sending and receiving data) with food waste reduction program 122 via network 110. In general, user computing devices 130_{1-N} represent any programmable electronic device or a combination of programmable electronic devices capable of executing machine readable program instructions and communicating with other computing devices (not shown) within distributed data processing environment 100 via network 110. In the depicted embodiment, each user computing device (e.g., user computing devices 130_{1-N}) includes an instance of a user interface (e.g., user interfaces 132_{1-N}) and a camera (e.g., cameras 134_{1-N}).

User interfaces 132_{1-N} operate as local user interfaces between food waste reduction program 122 on server 120 and a user of user computing devices 130_{1-N}. As used herein, N represents a positive integer, and accordingly the number of scenarios implemented in a given embodiment of the present invention is not limited to those depicted in FIG. 1. In some embodiments, user interfaces 132_{1-N} are a graphical user interface (GUI), a web user interface (WUI), and/or a voice user interface (VUI) that can display (i.e., visually) or present (i.e., audibly) text, documents, web browser windows, user options, application interfaces, and instructions for operations sent from food waste reduction program 122 to a user via network 110. User interfaces 132_{1-N} can also display or present alerts including information (such as graphics, text, and/or sound) sent from food waste reduction program 122 to a user via network 110. In an embodiment, user interfaces 132_{1-N} can send and receive data (i.e., to and from food waste reduction program 122 via network 110, respectively). Through user interfaces 132_{1-N}, a user can opt-in to food waste reduction program 122; input a set of personal data about the user; create a user profile; set user preferences and alert notification preferences; input an inventory of a smart refrigerator; input a set of data related to the inventory of the smart refrigerator; input a request for a recipe suggestion to be generated; receive a recipe suggestion; accept or reject the recipe suggestion; receive an alert notification, notifying the user of food to purchase at a supermarket; select a central location to deliver one or more products gathered; receive a composting method; receive an alert notification; receive a request for feedback; and input feedback.

A user preference is a setting that can be customized for a particular user. A set of default user preferences are assigned to each user of food waste reduction program 122. A user preference editor can be used to update values to change the default user preferences. User preferences that can be customized include, but are not limited to, general user system settings, specific user profile settings, alert notification settings, and machine-learned data collection/storage settings. Machine-learned data is a user's personalized corpus of data. Machine-learned data includes, but is not limited to, past results of iterations of food waste reduction program 122.

Cameras 134_{1-N} operate to capture a picture of each product in a smart refrigerator to be used to calculate an age of each product. As used herein, N represents a positive integer, and accordingly the number of scenarios implemented in a given embodiment of the present invention is not limited to those depicted in FIG. 1. Cameras 134_{1-N} capture a still and/or moving picture within a 360-degree view of cameras 134_{1-N}. Cameras 134_{1-N} capture the still and/or moving picture when the user adds a product to the smart refrigerator (e.g., smart refrigerators 140_{1-N}) and/or removes a product from the smart refrigerator (e.g., smart refrigerators 140_{1-N}). In the depicted embodiment, each camera (e.g., camera 134_{1-N}) is included in an instance of a user computer device (e.g., user computing device 130_{1-N}).

Smart refrigerators 140_{1-N} operate to store food, drinks, and other perishable items at a cool temperature. As used herein, N represents a positive integer, and accordingly the number of scenarios implemented in a given embodiment of the present invention is not limited to those depicted in FIG. 1. In an embodiment, smart refrigerators 140_{1-N} operate in a virtual refrigerator network. The virtual refrigerator network may include, but is not limited to, one or more smart refrigerators (e.g., smart refrigerators 140_{1-N}) of one or more users. The one or more smart refrigerators may be, but are not limited to, a box, a room, a cabinet, and a storage unit (e.g., a cold storage unit and a cupboard) in which food, drinks, and other perishable items can be properly refrigerated and stored. In the depicted embodiment, each smart refrigerator (e.g., smart refrigerators 140_{1-N}) includes an instance of a camera (e.g., cameras 142_{1-N}).

Cameras 142_{1-N} operate to gather an inventory of smart refrigerators 140_{1-N}. As used herein, N represents a positive integer, and accordingly the number of scenarios implemented in a given embodiment of the present invention is not limited to those depicted in FIG. 1. Cameras 142_{1-N} capture a still and/or moving picture within a 360-degree view of cameras 142_{1-N}. Cameras 142_{1-N} capture the still and/or moving picture when the user adds a product to the smart refrigerator (e.g., smart refrigerators 140_{1-N}) and/or removes a product from the smart refrigerator (e.g., smart refrigerators 140_{1-N}). In the depicted embodiment, each camera (e.g., camera 142_{1-N}) is included in an instance of a smart refrigerator (e.g., smart refrigerator 140_{1-N}). Each camera (e.g., cameras 142_{1-N}) is in a door of a smart refrigerator (e.g., smart refrigerators 140_{1-N}).

Drones 150_{1-N} operate to gather one or more products from a user and one or more contributing users and to deliver the one or more products gathered to the central location. Additionally, drones 150_{1-N} operates to deliver a respective portion of a meal and any food waste resulting from the preparation of the meal as compost to the household determined to have the worst ground conditions in order to promote resource efficiency. As used herein, N represents a positive integer, and accordingly the number of scenarios implemented in a given embodiment of the present invention is not limited to those depicted in FIG. 1. In the depicted embodiment, each drone (e.g., drones 150_{1-N}) includes an instance of a camera (e.g., cameras 152_{1-N}).

Cameras 152_{1-N} operate to capture a picture of a ground condition of each household from which the one or more products are gathered. As used herein, N represents a positive integer, and accordingly the number of scenarios implemented in a given embodiment of the present invention is not limited to those depicted in FIG. 1. Cameras 152_{1-N} capture a still and/or moving picture within a 360-degree view of cameras 152_{1-N}. In the depicted embodiment, each camera (e.g., camera 152_{1-N}) is included in an instance of a drone (e.g., drones 150_{1-N}).

FIG. 2 is a flowchart, generally designated 200, illustrating the operational steps for food waste reduction program 122, on server 120 within distributed data processing environment 100 of FIG. 1, in accordance with an embodiment of the present invention. In an embodiment, food waste reduction program 122 operates to create a virtual network of smart refrigerators, including a user's smart refrigerator and one or more community members' smart refrigerators, and to track a plurality of food inventories using visual inspection. In an embodiment, food waste reduction program 122 operates to monitor the freshness of food in the virtual network of smart refrigerators and to suggest one or more recipes based on a freshness level and/or an expiration date of the food in the virtual network of smart refrigerators to reduce food waste. In an embodiment, food waste reduction program 122 operates to use a drone to gather one or more ingredients of the one or more recipes suggested and to deliver the one or more ingredients and/or a pre-prepared meal to a user to promote resource efficiency. In an embodiment, food waste reduction program 122 operates to analyze a condition of one or more plants in a user's yard and to suggest a way to compost food waste to promote environmental sustainability. It should be appreciated that the process depicted in FIG. 2 illustrates one possible iteration of the process flow, which may be repeated for each user of a virtual refrigerator network and which may be repeated continuously while the virtual refrigerator network is active in order to reduce an overall amount of food waste within the virtual refrigerator network.

In step 210, food waste reduction program 122 creates a virtual refrigerator network. The virtual refrigerator network may include, but is not limited to, one or more smart refrigerators (e.g., smart refrigerators 140_{1-N}) of one or more users. The one or more users may include, but are not limited to, an individual, a household, a restaurant, a business, and a hotel. In an embodiment, food waste reduction program 122 creates a virtual refrigerator network by connecting a first smart refrigerator (e.g., smart refrigerator 140_{X}) of a first user to a second smart refrigerator (e.g., smart refrigerator 140_{Y}) of a second user. In an embodiment, food waste reduction program 122 repeats until the first smart refrigerator (e.g., smart refrigerator 140_{X}) of the first user is connected to each smart refrigerator located in the virtual refrigerator network (i.e., repeats to connect each smart refrigerator of a plurality of smart refrigerators (e.g., smart refrigerators 140_{1-N} in the virtual refrigerator network). The virtual refrigerator network includes, but is not limited to, one or more users who are located within a pre-determined distance from a pre-set point (i.e., located within a pre-determined distance from each other) and who were previously granted access to be a part of the virtual refrigerator network and who previously granted access to be connected with other users in the virtual refrigerator network. The one or more additional users may include, but are not limited to, a family member of a user, a community member of a user, and a member located within a pre-determined distance of a user. The distance of the user is pre-determined using an address of a home or a business of the user. In an embodiment, food waste reduction program 122 connects a first smart refrigerator (e.g., smart refrigerator 140_{X}) of a first user to a second smart refrigerator (e.g., smart refrigerator 140_{Y}) of a second user through an application programming interface (API).

In an embodiment, food waste reduction program 122 creates a user profile for a user. In an embodiment, food waste reduction program 122 creates a user profile for a user from a set of personal data input by the user via a user interface (e.g., user interface 132_{X}) of a user computing device (e.g., user computing device 130_{X}). The set of personal data input by the user may include, but is not limited to, personal information about the user (e.g., name, age, home address, capacity of a kitchen and/or preparation space, demand to make a specific type of food); user preferences and alert notification preferences; one or more dietary restrictions of the user; information about one or more products (e.g., an expiration date of the one or more products) in the smart refrigerator (e.g., smart refrigerator 140_{X}) of the user; and information on a condition of one or more plants in a yard of the user. In an embodiment, food waste reduction program 122 creates a user profile for the user from a set of data gathered from a camera (e.g., camera 142_{X}) of the smart refrigerator (e.g., smart refrigerator 140_{X}) of the user. The set of data gathered from the camera (e.g., camera 142_{X}) may include, but is not limited to, information about one or more products (e.g., an expiration date of the one or more products) in the smart refrigerator (e.g., smart refrigerator 140_{X}) of the user. In an embodiment, food waste reduction program 122 creates a user profile for the user from a set of data gathered from a drone (e.g., drone 150_{X}). The set of data gathered from the drone (e.g., drone 150_{X}) may include, but is not limited to, information on a condition of one or more plants in a yard of the user. In an embodiment, food waste reduction program 122 stores the user profile in a database (e.g., database 124). In an embodiment, food waste reduction program 122 stores the set of personal data input by the user, the set of data gathered from the camera, and the set of data gathered from the drone in a database (e.g., database 124).

In step 220, food waste reduction program 122 gathers an inventory of the smart refrigerator (e.g., smart refrigerator 140_{X}) of the user. The inventory of the smart refrigerator (e.g., smart refrigerator 140_{X})includes any food, drinks, and other perishable items (hereinafter referred to as “at least one product”) stored in the smart refrigerator (e.g., smart refrigerator 140_{X}). In an embodiment, food waste reduction program 122 gathers an inventory of the smart refrigerator (e.g., smart refrigerator 140_{X}) of the user from the user. In an embodiment, food waste reduction program 122 enables the user to input the inventory of the smart refrigerator (e.g., smart refrigerator 140_{X}) via a user interface (e.g., user interface 132_{X}) of a user computing device (e.g., user computing device 130_{X}). In another embodiment, food waste reduction program 122 gathers an inventory of the smart refrigerator (e.g., smart refrigerator 140_{X}) of the user from a camera (e.g., camera 142_{X}) located in a door of the smart refrigerator (e.g., smart refrigerator 140_{X}). In an embodiment, food waste reduction program 122 updates the inventory of the smart refrigerator (e.g., smart refrigerator 140_{X}) in the user profile of the user (i.e., to reflect the at least one product stored in the smart refrigerator (e.g., smart refrigerator 140_{X}) at the present time). In an embodiment, food waste reduction program 122 stores the inventory of the smart refrigerator (e.g., smart refrigerator 140_{X}) of the user in a database (e.g., database 124).

In another embodiment, when the user shops at a supermarket, food waste reduction program 122 connects to a virtual shopping cart of the supermarket. In an embodiment, food waste reduction program 122 tracks one or more products added to the virtual shopping cart of the supermarket. In an embodiment, food waste reduction program 122 validates the one or more products against the inventory of the smart refrigerator (e.g., smart refrigerator 140_{X}). In an embodiment, responsive to determining that there is no risk of food waste, food waste reduction program 122 updates the inventory of the smart refrigerator (e.g., smart refrigerator 140_{X}) in the user profile of the user (i.e., to reflect the at least one product to be purchased at the supermarket and be added to the smart refrigerator (e.g., smart refrigerator 140_{X})). In an embodiment, responsive to determining that there is a risk of food waste, food waste reduction program 122 outputs an alert notification to the user, notifying the user of the risk of food waste. There may be a risk of food waste at times including, but not limited to, when the user is purchasing a repeat product (i.e., a product in the inventory of the smart refrigerator at the present time) and when the user is purchasing a product the user previously purchased but did not use. In an embodiment, food waste reduction program 122 outputs an alert notification to the user, notifying the user of the risk of food waste. In an embodiment, food waste reduction program 122 outputs an alert notification to the user via a user interface (e.g., user interface 132_{X}) of a user computing device (e.g., user computing device 130_{X}).

In an embodiment, food waste reduction program 122 gathers a set of data related to the inventory of the smart refrigerator (e.g., smart refrigerator 140_{X}). The set of data related to the inventory may include, but is not limited to, a freshness level and an expiration date of each product in the smart refrigerator. In an embodiment, food waste reduction program 122 gathers a set of data related to the inventory of the smart refrigerator (e.g., smart refrigerator 140_{X}) from the user. In an embodiment, food waste reduction program 122 enables the user to input the set of data related to the inventory of the smart refrigerator (e.g., smart refrigerator 140_{X}) via a user interface (e.g., user interface 132_{X}) of a user computing device (e.g., user computing device 130_{X}). In another embodiment, food waste reduction program 122 gathers a set of data related to the inventory from a camera (e.g., camera 142_{X}) in a door of the smart refrigerator (e.g., smart refrigerator 140_{X}). In an embodiment, food waste reduction program 122 updates the set of data related to the inventory in the user profile of the user (i.e., to reflect the at least one product stored in the smart refrigerator (e.g., smart refrigerator 140_{X}) at the present time). In an embodiment, food waste reduction program 122 stores the set of data related to the inventory of the smart refrigerator (e.g., smart refrigerator 140_{X}) in a database (e.g., database 124).

In an embodiment, food waste reduction program 122 calculates an age of each product in the smart refrigerator (e.g., smart refrigerator 140_{X}). In an embodiment, if a product is a fruit or vegetable, food waste reduction program 122 calculates an age of each product in the smart refrigerator (e.g., smart refrigerator 140_{X}) by comparing a first picture captured of each product in the smart refrigerator (e.g., smart refrigerator 140_{X}) to a second picture of the product from a library of pictures. In an embodiment, food waste reduction program 122 enables the user to input the first picture captured of each product via a camera (e.g., camera 134_{X}) of a user computing device (e.g., user computing device 130_{X}). In an embodiment, food waste reduction program 122 uses the first picture captured of each product by the user for the comparison. In another embodiment, food waste reduction program 122 uses the first picture captured of each product by the camera (e.g., camera 142_{X}) in the door of the smart refrigerator (e.g., smart refrigerator 140_{X}) for the comparison. In an embodiment, food waste reduction program 122 compares the first picture captured of a first product to a second picture captured of a second product from a library of pictures of the one or more additional users using a technological device known in the art (e.g., IBM® Maximo® Visual Inspection). In an embodiment, food waste reduction program 122 determines whether the color of the first product in the first picture captured is similar to the color of the second product in the second picture captured from the library of pictures.

In an embodiment, food waste reduction program 122 creates a First-In-First-Out (FIFO) list. In an embodiment, food waste reduction program 122 creates a FIFO list of the inventory of the smart refrigerator (e.g., smart refrigerator 140_{X}). In an embodiment, food waste reduction program 122 updates the FIFO list in the user profile of the user (i.e., to reflect the at least one product stored in the smart refrigerator (e.g., smart refrigerator 140_{X}) at the present time). In an embodiment, food waste reduction program 122 stores the FIFO list in a database (e.g., database 124).

In step 230, food waste reduction program 122 generates a recipe suggestion. In an embodiment, food waste reduction program 122 generates a recipe suggestion automatically. In an embodiment, food waste reduction program 122 generates a recipe suggestion automatically when one or more products in the smart refrigerator (e.g., smart refrigerator 140_{X}) have a freshness level and/or an expiration date within a pre-determined threshold. In another embodiment, food waste reduction program 122 generates a recipe suggestion automatically when one or more products in a combination of the smart refrigerator (e.g., smart refrigerator 140_{X}) and one or more smart refrigerators (e.g., smart refrigerators 140_{1-N}) in the virtual refrigerator network have a freshness level and/or an expiration date within a pre-determined threshold. In another embodiment, food waste reduction program 122 generates a recipe suggestion when a request is input by the user via the user interface (e.g., user interface 132_{X}) of the user computing device (e.g., user computing device 130_{X}). The one or more recipe suggestions may include, but are not limited to, a list of the one or more products necessary to prepare a recipe suggestion and a list of the one or more smart refrigerators of the virtual refrigerator network that have the one or more products necessary to prepare the recipe suggestion. In an embodiment, food waste reduction program 122 considers a cost to transport the one or more products necessary to prepare the recipe suggestion to a central location where the recipe suggestion can be prepared. In an embodiment, food waste reduction program 122 considers whether the recipe suggestion must be consumed within a pre-set period of time of when the recipe suggestion is prepared. In an embodiment, food waste reduction program 122 considers whether the recipe suggestion needs an additional amount of time and effort to be prepared by the one or more users who contributed the one or more products. In an embodiment, food waste reduction program 122 considers whether a product of the recipe suggested can be stored (i.e., has an extended expiration date) (e.g., jam, jelly, processed fruit, processed vegetables). In an embodiment, food waste reduction program 122 outputs an alert notification to the user. In another embodiment, food waste reduction program 122 outputs an alert notification to the user and to the one or more users of the one or more smart refrigerators (e.g., smart refrigerators 140_{1-N}) in the virtual refrigerator network that have the one or more products necessary to prepare the recipe suggestion. In an embodiment, food waste reduction program 122 outputs an alert notification to the user, notifying the user of the recipe suggestion. The alert notification may include, but is not limited to, the recipe suggestion. In an embodiment, food waste reduction program 122 outputs an alert notification to the user via the user interface (e.g., user interface 132_{X}) of the user computing device (e.g., user computing device 130_{X}).

In step 240, food waste reduction program 122 enables the user to accept the recipe suggestion. In an embodiment, food waste reduction program 122 enables the one or more users of the one or more smart refrigerators (e.g., smart refrigerators 140_{1-N}) in the virtual refrigerator network who have the one or more products necessary to prepare the recipe suggestion to accept the recipe suggestion (hereinafter referred to as “one or more contributing users”). In an embodiment, food waste reduction program 122 enables the user to accept the recipe suggestion via the user interface (e.g., user interface 132_{X}) of the user computing device (e.g., user computing device 130_{X}). In another embodiment, food waste reduction program 122 enables the user to reject the recipe suggestion. In another embodiment, food waste reduction program 122 enables the user to propose another recipe suggestion.

In decision step 250, food waste reduction program 122 determines whether the user accepted the recipe suggestion. In an embodiment, food waste reduction program 122 determines whether the one or more contributing users accepted the recipe suggestion. In an embodiment, if food waste reduction program 122 determines the user and the one or more contributing users accepted the recipe suggestion (decision step 250, YES branch), then food waste reduction program 122 proceeds to step 260, gathering the one or more products from the user and the one or more contributing users. In an embodiment, if food waste reduction program 122 determines the user and/or the one or more contributing users rejected the recipe suggestion (decision step 250, NO branch), then food waste reduction program 122 proceeds to step 255, suggesting a food to purchase at the supermarket to the user.

In step 255, responsive to the user and/or the one or more contributing users rejecting the recipe suggestion, food waste reduction program 122 suggests a food to purchase at the supermarket. In an embodiment, food waste reduction program 122 outputs an alert notification to the user. In an embodiment, food waste reduction program 122 outputs an alert notification to the user, notifying the user of the food to purchase at the supermarket. In an embodiment, food waste reduction program 122 outputs an alert notification to the user via a user interface (e.g., user interface 132_{X}) of a user computing device (e.g., user computing device 130_{X}).

In step 260, responsive to the user and the one or more contributing users accepting the recipe suggestion, food waste reduction program 122 gathers the one or more products from the user and the one or more contributing users. In an embodiment, food waste reduction program 122 gathers the one or more products from the user and the one or more contributing users using a drone (e.g., drones 150_{1-N}). In an embodiment, food waste reduction program 122 gathers the one or more products from the user and the one or more contributing users to prepare the recipe suggestion.

In an embodiment, while gathering the one or more products from the user and the one or more contributing users, food waste reduction program 122 analyzes a ground condition of a first household of the one or more contributing users (i.e., from which the one or more products are gathered). In an embodiment, food waste reduction program 122 captures a picture of the ground condition of a first household of the one or more contributing users using a camera (e.g., camera 152_{1-N}) on the drone (e.g., drones 150_{1-N}). The ground condition of each household may include, but is not limited to, a flower, a plant, a tree, and an area of grass. In an embodiment, food waste reduction program 122 repeats this process for each household of the one or more contributing users. In an embodiment, food waste reduction program 122 stores the picture captured of the ground condition of each household of the one or more contributing users in a database (e.g., database 124).

In an embodiment, food waste reduction program 122 compares the picture captured of the ground condition of the first household to one or more pictures captured of the ground conditions of each household of the one or more contributing users. The comparison used may be based on, but is not limited to, a color of a plant and a condition of the plant. In an embodiment, food waste reduction program 122 ranks each household based on a result of the comparison of the ground condition of the respective household. In an embodiment, food waste reduction program 122 marks each household with one of three colors. The three colors are red (i.e., for the user who has the worst ground condition), yellow (i.e., for the user who has the moderate ground condition), and green (i.e., for the user who has the best ground condition). In an embodiment, food waste reduction program 122 determines which household has a ground condition that falls below a pre-determined threshold (i.e., the household with the worst ground conditions).

In an embodiment, food waste reduction program 122 selects a central location to deliver the one or more products gathered. The central location may be, but is not limited to, a user designated to prepare the recipe suggestion. In another embodiment, food waste reduction program 122 enables the user to select a central location to deliver the one or more products gathered via a user interface (e.g., user interface 132_{X}) of a user computing device (e.g., user computing device 130_{X}). In an embodiment, food waste reduction program 122 designates the central location with a symbol of a star. In an embodiment, food waste reduction program 122 delivers the one or more products gathered to the central location. In an embodiment, food waste reduction program 122 delivers the one or more products gathered to the central location using a drone (e.g., drones 150_{1-N}). In an embodiment, if the recipe suggestion has a product that the user and/or the one or more contributing users do not have, food waste reduction program 122 enables the user and/or the one or more contributing users to purchase the product from the supermarket.

In step 270, food waste reduction program 122 determines a meal has been prepared. In an embodiment, food waste reduction program 122 determines a meal has been prepared after a pre-determined threshold period of time. In another embodiment, food waste reduction program 122 determines a meal has been prepared via an alert notification sent from the user designated to prepare the recipe suggestion via a user computing device (e.g., user computing device 130_{X}).

In step 280, responsive to determining that the meal has been prepared, food waste reduction program 122 delivers a respective portion of the meal. In an embodiment, food waste reduction program 122 delivers a respective portion of the meal to each household of the user and the one or more contributing users. In an embodiment, food waste reduction program 122 delivers a respective portion of the meal using a drone (e.g., drones 150_{1-N}).

In step 290, while delivering the respective portions of the meal, food waste reduction program 122 transports food waste resulting from the preparation of the meal from the user designated to prepare the recipe suggestion to the household with the worst ground conditions. In another embodiment, food waste reduction program 122 transports a smart composting device along with the food waste to ease the composting process. The household that receives the food waste may be selected based, at least in part, on the analyzation of the ground conditions of the household while gathering the one or more products to prepare the recipe suggestion and on a determination that the ground conditions of the household are below a pre-determined threshold. In an embodiment, food waste reduction program 122 outputs a composting method to the household that receives the food waste. In an embodiment, food waste reduction program 122 outputs a composting method to the household that receives the food waste via a user interface (e.g., user interface 132_{X}) of a user computing device (e.g., user computing device 130_{X}). The composting method may be used to create a compost from the food waste resulting from the preparation of the meal. The compost created may then be used to improve the ground conditions of the household that receives the food waste.

In a first example of food waste reduction program 122, user X, a working parent with two young children, finds themself wasting food because user X does not have time to plan meals and grocery shop effectively. User X often ends up with perishable items that spoil before user X can use them, resulting in both financial and environmental waste. User X decides to try out food waste reduction program 122, which connects user X's fridge to a virtual refrigerator network. The application helps user X keep track of the contents of user X's fridge, as well as the expiration dates of each item. It also suggests recipes based on the ingredients user X has on hand, and sends them alerts when items are close to expiration. With the help of the application, user X is able to better plan their meals and grocery shopping, and is able to use their perishable items before the items spoil. User X notices a significant reduction in food waste and an improvement in user X's budget.

In a second example of food waste reduction program 122, a large office building has a communal kitchen for employees to use but finds that there is a lot of food waste due to the lack of coordination among employees. Some employees may leave perishable items in the fridge for extended periods of time, while others may not know what ingredients are available to them when planning their meals. The office building decides to implement food waste reduction program 122 to help manage the communal kitchen. Food waste reduction program 122 creates a virtual refrigerator network of all the refrigerators in the office, allowing employees to see the contents of each refrigerator and plan meals accordingly. Food waste reduction program 122 also suggests recipes based on the ingredients available and sends alert notifications when products are close to expiration. As a result, the office building is able to significantly reduce food waste and improve the efficiency of the communal kitchen. Employees are able to save time and resources, and the office is able to save money on food costs.

In a third example of food waste reduction program 122, a large grocery store chain is looking for ways to reduce food waste and improve efficiency. The large grocery store chain decides to implement food waste reduction program 122 in the large grocery store chain's stores, connecting all of the refrigerators and freezers to a virtual refrigerator network. Food waste reduction program 122 helps the stores keep track of the expiration dates of the perishable items and to suggest recipes to customers based on the ingredients available. Food waste reduction program 122 also sends alert notifications to employees when items are close to expiration, allowing the employees to remove the items from the shelves and donate or compost the items before the items spoil. As a result, the grocery store chain significantly reduces food waste and improves the efficiency of the grocery store chain's operations. The grocery store chain saves money on food costs and reduces the grocery store chain's environmental impact.

FIG. 3A depicts a diagram, generally designated 300-A, illustrating an initialization of a virtual refrigerator network, on server 120 within distributed data processing environment 100 of FIG. 1, in accordance with an embodiment of the present invention. It should be appreciated that FIG. 3A provides only an illustration of one implementation and does not imply any limitations with regard to the environments in which different embodiments can be implemented. Many modifications to the depicted environment can be made. Food waste reduction program 122 initializes a virtual refrigerator network (e.g., 305-A). The virtual refrigerator network includes three smart refrigerators (e.g., smart refrigerator 310-A₁ of user 1, smart refrigerator 310-A₂ of user 2, and smart refrigerator 310-A₃ of user 3). Food waste reduction program 122 connects smart refrigerator 310-A₁ of user 1 to smart refrigerator 310-A₂ of user 2 and smart refrigerator 310-A₃ of user 3. User 1, user 2, and user 3 are members of the Oswego, New York community and are located within a pre-determined distance of user 1. The pre-determined distance is equal to 3 kilometers (km).

FIG. 3B depicts a diagram, generally designated 300-B, illustrating a generation of a recipe with one or more products having a freshness level and/or an expiration date within a pre-determined threshold, on server 120 within distributed data processing environment 100 of FIG. 1, in accordance with an embodiment of the present invention. It should be appreciated that FIG. 3B provides only an illustration of one implementation and does not imply any limitations with regard to the environments in which different embodiments can be implemented. Many modifications to the depicted environment can be made. Food waste reduction program 122 generates a recipe for a salad with dressing (e.g., 305-B) automatically. One or more products in smart refrigerator 310-A₁ of user 1, smart refrigerator 310-A₂ of user 2, and smart refrigerator 310-A₃ of user 3 have a freshness level and/or an expiration date within a pre-determined threshold. More specifically, user 1 has salad dressing (e.g., 310-B₁) in smart refrigerator 310-A₁. User 2 has lettuce and carrots (e.g., 310-B₂) in smart refrigerator 310-A₂. User 3 has a tomato and an onion (e.g., 310-B₃) in smart refrigerator 310-A₃. Food waste reduction program 122 designates user 3 as the central location and designates user 3 with a star symbol (e.g., 315-B). Food waste reduction program 122 gathers the ingredients for the salad with dressing from user 1 and user 2 and delivers the ingredients to user 3 using a drone (e.g., 320-B).

FIG. 3C depicts a diagram, generally designated 300-C, illustrating a gathering of the one or more products for the recipe generated using a drone, on server 120 within distributed data processing environment 100 of FIG. 1, in accordance with an embodiment of the present invention. It should be appreciated that FIG. 3C provides only an illustration of one implementation and does not imply any limitations with regard to the environments in which different embodiments can be implemented. Many modifications to the depicted environment can be made. Food waste reduction program 122 gathers the ingredients for the salad with dressing (e.g., 305-C) from user 1 and user 2 and delivers the ingredients to user 3 using a drone (e.g., 320-B).

FIG. 3D depicts a diagram, generally designated 300-D, illustrating an analyzation of a ground condition of a household to determine where to send compost created from food waste resulting from a preparation of a meal, on server 120 within distributed data processing environment 100 of FIG. 1, in accordance with an embodiment of the present invention. It should be appreciated that FIG. 3D provides only an illustration of one implementation and does not imply any limitations with regard to the environments in which different embodiments can be implemented. Many modifications to the depicted environment can be made. While gathering the one or more products from the first user and the one or more contributing users within the virtual refrigerator network, food waste reduction program 122 analyzes a ground condition of each household of the first user and the one or more contributing users. Food waste reduction program 122 captures a picture of the ground condition of each household of the first user and the one or more contributing users using a camera (e.g., camera 152_{1-N}) on the drone (e.g., drones 150_{1-N}). Food waste reduction program 122 determines which household has the worst ground conditions by comparing the pictures taken. While delivering a respective portion of a meal, food waste reduction program 122 delivers food waste resulting from the preparation of the meal as compost to the household determined to have the worst ground conditions. In an embodiment, food waste reduction program 122 delivers food waste resulting from the preparation of the meal as compost to the household determined to have the worst ground conditions using the drone (e.g., drones 150_{1-N}).

FIG. 4 depicts a diagram, generally designated 400, illustrating a formation of a supply chain network between a supermarket and one or more restaurants, on server 120 within distributed data processing environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made. Food waste reduction program 122 dynamically forms a supply chain network between a supermarket (e.g., 405₁) and two restaurants (e.g., 405₂ and 405₃). Food waste reduction program 122 directs drones (e.g., 415₁ and 415₂) to transport food (e.g., carrots 410₁ and tomatoes 410₂) sold by the supermarket and close to its expiration date from the supermarket (e.g., 405₁) to the two restaurants (e.g., 405₂ and 405₃) to be used in a recipe before the food expires.

FIG. 5 depicts a block diagram, generally designated 500, of components of server 120 within distributed data processing environment 100 of FIG. 1, in accordance with an embodiment of the present invention. It should be appreciated that FIG. 5 provides only an illustration of one implementation and does not imply any limitations with regard to the environments in which different embodiments can be implemented. Many modifications to the depicted environment can be made.

Computing environment 500 contains an example of an environment for the execution of at least some of the computer code involved in performing the inventive methods, such as food waste reduction program 122. In addition to food waste reduction program 122, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and food waste reduction program 122, as identified above), peripheral device set 514 (including user interface (UI), device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

Computer 501, which represents server 120 of FIG. 1, may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

Processor set 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in food waste reduction program 122 in persistent storage 513.

Communication fabric 511 is the signal conduction paths that allow the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 512 is any type of volatile memory now known or to be developed in the future. Examples include dynamic type random access memory (RAM) or static type RAM. Typically, the volatile memory is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

Persistent storage 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid-state storage devices. Operating system 522 may take several forms, such as various known proprietary operating systems or open-source Portable Operating System Interface type operating systems that employ a kernel. The code included in food waste reduction program 122 typically includes at least some of the computer code involved in performing the inventive methods.

Peripheral device set 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

Network module 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 503 is any computer system that is used and controlled by an end user (for example, a customer of an enterprise that operates computer 501) and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

Remote server 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

Public cloud 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The foregoing descriptions of the various embodiments of the present invention have been presented for purposes of illustration and example but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
creating, by one or more processors, a virtual refrigerator network by connecting a plurality of smart refrigerators;
gathering, by the one or more processors, an inventory of one or more products stored in the plurality of smart refrigerators and a set of data related to the inventory, wherein the set of data related to the inventory includes at least one of a freshness level of the one or more products and an expiration date of the one or more products;
generating, by the one or more processors, a recipe suggestion based on the one or more products stored in the plurality of smart refrigerators, wherein the one or more products have at least one of the freshness level and the expiration date within a first predetermined threshold;
responsive to one or more users each associated with one or more of the plurality of smart refrigerators accepting the recipe suggestion, gathering, by the one or more processors, a subset of the one or more products involved in the recipe suggestion from respective smart refrigerators of the plurality of smart refrigerators to prepare the recipe suggestion, wherein the subset of the one or more products gathered are delivered to a central location; and
responsive to determining a meal has been prepared, delivering, by the one or more processors, a respective portion of the meal to each household of the one or more users.

2. The computer-implemented method of claim 1, wherein the plurality of smart refrigerators is each connected through an application programming interface.

3. The computer-implemented method of claim 1, wherein each of the plurality of smart refrigerators are located within a pre-determined distance from each other.

4. The computer-implemented method of claim 1, wherein creating the virtual refrigerator network by connecting the plurality of smart refrigerators further comprises:
creating, by the one or more processors, a first user profile for a first user associated with a first smart refrigerator of the plurality of smart refrigerators from a set of data input by at least one of the first user, a first camera located in a first door of the first smart refrigerator, and a drone; and
storing, by the one or more processors, the first user profile in a database.

5. The computer-implemented method of claim 1, wherein the inventory of the one or more products stored in the plurality of smart refrigerators and the set of data related to the inventory are gathered from at least one of the one or more users each associated with the one or more of the plurality of smart refrigerators and one or more of a plurality of cameras located in one or more of a plurality of doors of the one or more of the plurality of smart refrigerators.

6. The computer-implemented method of claim 1, wherein gathering the inventory of the one or more products stored in the plurality of smart refrigerators and the set of data related to the inventory further comprises:
responsive to the first user shopping at a supermarket for the one or more products, connecting, by the one or more processors, to a virtual shopping cart of the supermarket;
tracking, by the one or more processors, the one or more products added to the virtual shopping cart of the supermarket;
validating, by the one or more processors, the one or more products against an inventory of the first smart refrigerator of the plurality of smart refrigerators; and
responsive to determining that there is a risk of food waste, outputting, by the one or more processors, an alert notification to the first user.

7. The computer-implemented method of claim 1, wherein gathering the inventory of the one or more products stored in the plurality of smart refrigerators and the set of data related to the inventory further comprises:
comparing, by the one or more processors, a first picture of a first product input by at least one of the first user associated with a first smart refrigerator of the plurality of smart refrigerators and the first camera of the one or more of the plurality of cameras located in the one or more of the plurality of doors of the one or more of the plurality of smart refrigerators to a second product in a second picture from a library of pictures;
determining, by the one or more processors, whether a color of the first product is similar to a color of the second product in the second picture in the library of pictures; and
calculating, by the one or more processors, an age of the first product.

8. The computer-implemented method of claim 1, furthering comprising:
delivering, by the one or more processors, while delivering the respective portion of the meal to each household of the one or more users, food waste resulting from a preparation of the meal to be used as compost, the first household being selected based, at least in part, on:
analyzing, by the one or more processors, a ground condition of the first household when gathering the one or more products from the one or more users to prepare the recipe suggestion; and
determining, by the one or more processors, the ground condition of the first household is below a second predetermined threshold.

9. The computer-implemented method of claim 1, wherein the respective portion of the meal is delivered to each household of the first user and the one or more contributing users using a drone.

10. A computer program product comprising:
one or more computer readable storage media and program instructions stored on the one or more computer readable storage media, the program instructions comprising:
program instructions to create a virtual refrigerator network by connecting a plurality of smart refrigerators;
program instructions to gather an inventory of one or more products stored in the plurality of smart refrigerators and a set of data related to the inventory, wherein the set of data related to the inventory includes at least one of a freshness level of the one or more products and an expiration date of the one or more products;
program instructions to generate a recipe suggestion based on the one or more products stored in the plurality of smart refrigerators, wherein the one or more products have at least one of the freshness level and the expiration date within a first predetermined threshold;
responsive to one or more users each associated with one or more of the plurality of smart refrigerators accepting the recipe suggestion, program instructions to gather a subset of the one or more products involved in the recipe suggestion from respective smart refrigerators of the plurality of smart refrigerators to prepare the recipe suggestion, wherein the subset of the one or more products gathered are delivered to a central location; and
responsive to determining a meal has been prepared, program instructions to deliver a respective portion of the meal to each household of the one or more users.

11. The computer program product of claim 10, wherein creating the virtual refrigerator network by connecting the plurality of smart refrigerators further comprises:
program instructions to create a first user profile for a first user associated with a first smart refrigerator of the plurality of smart refrigerators from a set of data input by at least one of the first user, a first camera located in a first door of the first smart refrigerator, and a drone; and
program instructions to store the first user profile in a database.

12. The computer program product of claim 10, wherein gathering the inventory of the one or more products stored in the plurality of smart refrigerators and the set of data related to the inventory further comprises:
responsive to the first user shopping at a supermarket for the one or more products, program instructions to connect to a virtual shopping cart of the supermarket;
program instructions to track the one or more products added to the virtual shopping cart of the supermarket;
program instructions to validate the one or more products against an inventory of the first smart refrigerator of the plurality of smart refrigerators; and
responsive to determining that there is a risk of food waste, program instructions to output an alert notification to the first user.

13. The computer program product of claim 10, wherein gathering the inventory of the one or more products stored in the plurality of smart refrigerators and the set of data related to the inventory further comprises:
program instructions to compare a first picture of a first product input by at least one of the first user associated with a first smart refrigerator of the plurality of smart refrigerators and the first camera of the one or more of the plurality of cameras located in the one or more of the plurality of doors of the one or more of the plurality of smart refrigerators to a second product in a second picture from a library of pictures;
program instructions to determine whether a color of the first product is similar to a color of the second product in the second picture in the library of pictures; and
program instructions to calculate an age of the first product.

14. The computer program product of claim 10, furthering comprising:
program instructions to deliver, while delivering the respective portion of the meal to each household of the one or more users, food waste resulting from a preparation of the meal to be used as compost, the first household being selected based, at least in part, on:
program instructions to analyze a ground condition of the first household when gathering the one or more products from the one or more users to prepare the recipe suggestion; and
program instructions to determine the ground condition of the first household is below a second predetermined threshold.

15. The computer program product of claim 10, wherein the respective portion of the meal is delivered to each household of the first user and the one or more contributing users using a drone.

16. A computer system comprising:
one or more computer processors;
one or more computer readable storage media;
program instructions collectively stored on the one or more computer readable storage media for execution by at least one of the one or more computer processors, the stored program instructions comprising:
program instructions to create a virtual refrigerator network by connecting a plurality of smart refrigerators;
program instructions to gather an inventory of one or more products stored in the plurality of smart refrigerators and a set of data related to the inventory, wherein the set of data related to the inventory includes at least one of a freshness level of the one or more products and an expiration date of the one or more products;
program instructions to generate a recipe suggestion based on the one or more products stored in the plurality of smart refrigerators, wherein the one or more products have at least one of the freshness level and the expiration date within a first predetermined threshold;
responsive to one or more users each associated with one or more of the plurality of smart refrigerators accepting the recipe suggestion, program instructions to gather a subset of the one or more products involved in the recipe suggestion from respective smart refrigerators of the plurality of smart refrigerators to prepare the recipe suggestion, wherein the subset of the one or more products gathered are delivered to a central location; and
responsive to determining a meal has been prepared, program instructions to deliver a respective portion of the meal to each household of the one or more users.

17. The computer system of claim 16, wherein creating the virtual refrigerator network by connecting the plurality of smart refrigerators further comprises:
program instructions to create a first user profile for a first user associated with a first smart refrigerator of the plurality of smart refrigerators from a set of data input by at least one of the first user, a first camera located in a first door of the first smart refrigerator, and a drone; and
program instructions to store the first user profile in a database.

18. The computer system of claim 16, wherein gathering the inventory of the one or more products stored in the plurality of smart refrigerators and the set of data related to the inventory further comprises:
responsive to the first user shopping at a supermarket for the one or more products, program instructions to connect to a virtual shopping cart of the supermarket;
program instructions to track the one or more products added to the virtual shopping cart of the supermarket;
program instructions to validate the one or more products against an inventory of the first smart refrigerator of the plurality of smart refrigerators; and
responsive to determining that there is a risk of food waste, program instructions to output an alert notification to the first user.

19. The computer system of claim 16, wherein gathering the inventory of the one or more products stored in the plurality of smart refrigerators and the set of data related to the inventory further comprises:
program instructions to compare a first picture of a first product input by at least one of the first user associated with a first smart refrigerator of the plurality of smart refrigerators and the first camera of the one or more of the plurality of cameras located in the one or more of the plurality of doors of the one or more of the plurality of smart refrigerators to a second product in a second picture from a library of pictures;
program instructions to determine whether a color of the first product is similar to a color of the second product in the second picture in the library of pictures; and
program instructions to calculate an age of the first product.

20. The computer system of claim 16, furthering comprising:
program instructions to deliver, while delivering the respective portion of the meal to each household of the one or more users, food waste resulting from a preparation of the meal to be used as compost, the first household being selected based, at least in part, on:
program instructions to analyze a ground condition of the first household when gathering the one or more products from the one or more users to prepare the recipe suggestion; and
program instructions to determine the ground condition of the first household is below a second predetermined threshold.
